(19) United States
(12) Patent Application Publication
(10) Pub. No.: US 2025/0336621 A1
(43) Pub. Date: Oct. 30, 2025

(54) SWITCHING APPARATUS FOR ELECTRICAL SYSTEMS

(71) Applicant: ABB S.p.A, Milano (IT)

(72) Inventors: Ilario Triscari, Västerås (SE); Roberto Rota Martir, Brembate Sopra (BG) (IT); Alessio Bergamini, Gazzaniga (BG) (IT)

(21) Appl. No.: 19/177,953

(22) Filed: Apr. 14, 2025

(30) Foreign Application Priority Data
Apr. 24, 2024 (EP) 24172091.1

(51) Int. Cl. H01H 9/34; H01H 3/04; H01H 3/46

(52) U.S. Cl. CPC H01H 9/34; H01H 3/04; H01H 3/46

(57) ABSTRACT

The present disclosure relates to a switching apparatus for low or medium voltage electrical systems, wherein said switching apparatus comprising one or more switch poles. For each switch pole, said switching apparatus comprises a first pole terminal and a second pole terminal couplable with corresponding conductors of an electric line. Additionally, for each switch pole, the switching apparatus further comprises a fixed contact assembly including at least a fixed contact member electrically connected to said first pole terminal and a movable contact assembly including at least a movable contact member electrically connected to said second pole terminal. Furthermore, for each switch pole, the switching apparatus additionally comprises a movable barrier structure including at least a barrier member made of an electrically insulating material.

### CROSS REFERENCE TO RELATED APPLICATIONS

The present application claims priority to European Patent Application No. 24172091.1 filed on Apr. 24, 2024, and titled “A SWITCHING APPARATUS FOR ELECTRICAL SYSTEMS”, which is hereby incorporated by reference in its entirety.

### TECHNICAL FIELD

The present disclosure relates to the field of electrical systems, such as electric grids, switchboards, and the like. More particularly, the present disclosure relates to a switching apparatus for low- or medium-voltage electrical systems.

### BACKGROUND

As it is known, an electrical system may include several switching apparatuses configured in such a way to allow a selective disconnection of electrical sections, for example when a fault event occurs.

Many switching apparatuses of the state of the art are of electromechanical type.

In general, these switching apparatuses have the advantage of ensuring a galvanic isolation between disconnected electric circuits.

Additionally, they are relatively cheap to realize at industrial level.

However, the experience has shown how these apparatuses do not often provide satisfactory interruption ratings, in particular when they have to interrupt DC currents at relatively high voltages (e.g. 1.5 kV DC or above). In these circumstances, in fact, their opening time can be relatively long. Electric arcs, which usually strike between electric contacts under separation, may consequently last for a long time, which is quite dangerous as many electrical components (e.g. photovoltaic panels and energy storage systems) electrically connected to the electric line can potentially feed an undergoing electric fault.

Furthermore, it has been seen that electric arcs may sometime strike towards other conductive parts or components of the switching apparatus, which may be subject to serious damages since they are not generally designed to bear high electric and thermal stresses.

The above-mentioned inconveniences are even made more critical by the circumstance that, in modern electrical systems, switching apparatuses are often brought to operate at high operating voltages. Electric arcs with a high energy content may thus arise between the electric contacts under separation during the opening maneuver of a switching apparatus.

Due to the above-mentioned criticalities, currently available switching apparatuses typically comprise a number of switch poles electrically connected in series when operating at relative high voltages. They are thus rather expensive to manufacture at industrial level and relatively difficult to install due to their huge size.

### BRIEF DESCRIPTION

The main aim of the present disclosure is to provide a switching apparatus for low or medium voltage electrical systems, which allows overcoming or mitigating the above-mentioned criticalities.

More particularly, an object of the present disclosure is to provide a switching apparatus ensuring performant interruption ratings in case of electric faults, especially in presence of short-circuit currents.

As a further object, the present disclosure aims at providing a switching apparatus having a compact structure and easy to install on the field.

Still another object of the present disclosure is to provide a switching apparatus, which can be easily manufactured at industrial level, at competitive costs relative to similar solutions of the state of the art.

### BRIEF DESCRIPTION OF DRAWINGS

Characteristics and advantages of the present disclosure will become more apparent from the detailed description of exemplary embodiments illustrated only by way of non-limitative example in the accompanying drawings.

FIGS. 1-3 schematically show an embodiment of the switching apparatus of the present disclosure.

FIG. 4-5 schematically show further embodiments of the switching apparatus of the present disclosure.

FIG. 6, 6a, 6b schematically shows a switch pole of the switching apparatus of the present disclosure according to some variants of the embodiment of FIG. 4.

FIG. 7 schematically shows a switch pole of the switching apparatus of the present disclosure in the embodiment of FIG. 5.

FIGS. 8-11 show the operation of a switch pole of the switching apparatus of the present disclosure in the embodiment of FIG. 4.

### DETAILED DESCRIPTION

With reference to the cited figures, the present disclosure relates to a switching apparatus 1 for electrical systems, such as electric grids, electric switchboards, and the like.

The switching apparatus 1 is particularly suitable for use in low-voltage DC electric grids and it will be described hereinafter with reference to these applications for the sake of brevity only, without intending to limit the scope of the present disclosure in any way.

The switching apparatus 1 may, in fact, be successfully used in electric systems of different type, such as low-voltage AC electric grids or medium-voltage AC or DC electric grids.

For the purpose of the present application, the term “low-voltage” (LV) relates to operating voltages lower than 1 kV AC and 1.5 kV DC whereas the term “medium-voltage” (MV) relates to operating voltages higher than 1 kV AC and 1.5 kV DC up to some tens of kV, e.g. up to 72 kV AC and 100 kV DC.

In some embodiments, the switching apparatus 1 is a circuit-breaker, and in some embodiments a low-voltage circuit breaker. However, in principle, it may be of different type, for example a contactor, a disconnector, and the like.

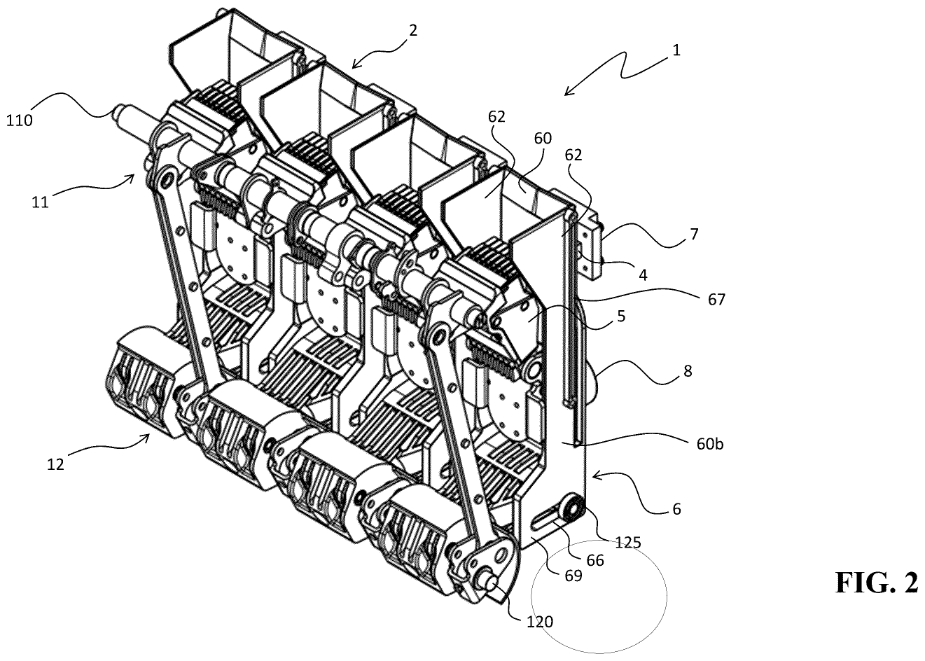

The switching apparatus 1 comprises one or more switch poles 2, for example four switch poles as shown in FIGS. 2-5.

In DC applications, the switch poles can be electrically connected in series one to another between the terminals of an electric line. In AC applications, each switch pole is electrically connected to an electric phase of an electric line.

In some embodiments, each switch pole 2 extends along a corresponding main longitudinal axis A. This latter is vertically oriented referring to a normal installation position of the switching apparatus as shown in the cited figures.

In some embodiments, the switch poles 2 extend in parallel one to another.

In some embodiments, each switch pole 2 comprises an outer shell 3 made of an electrically insulating material (e.g. a thermoplastic material) and defining an internal volume, in which the components of the switch pole are accommodated.

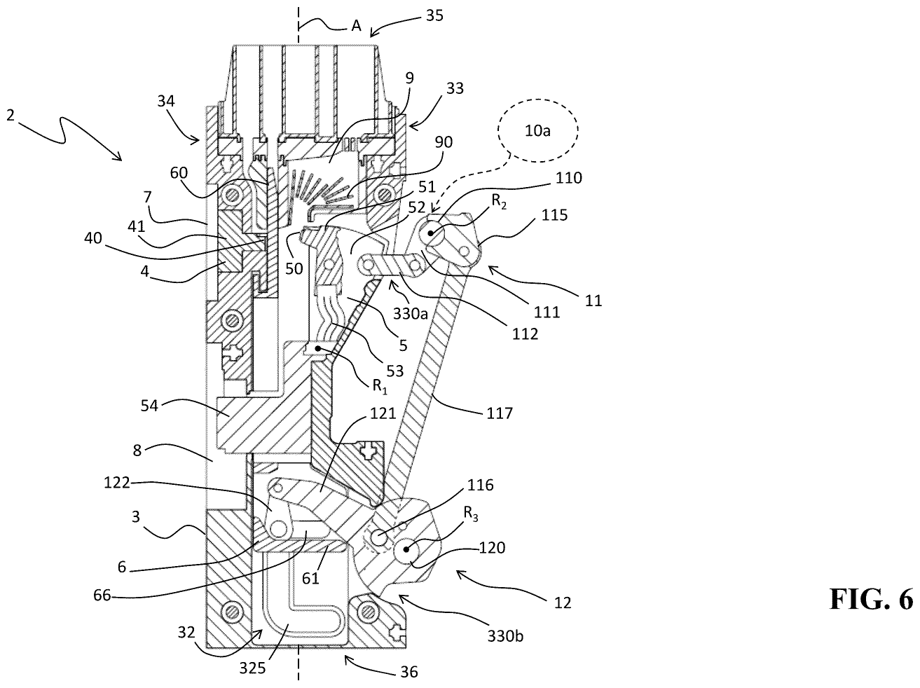

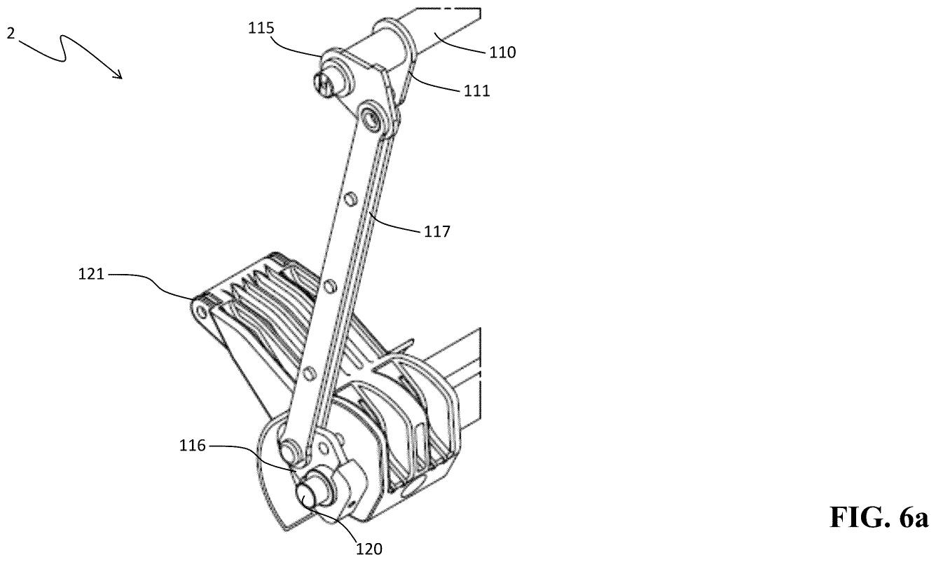

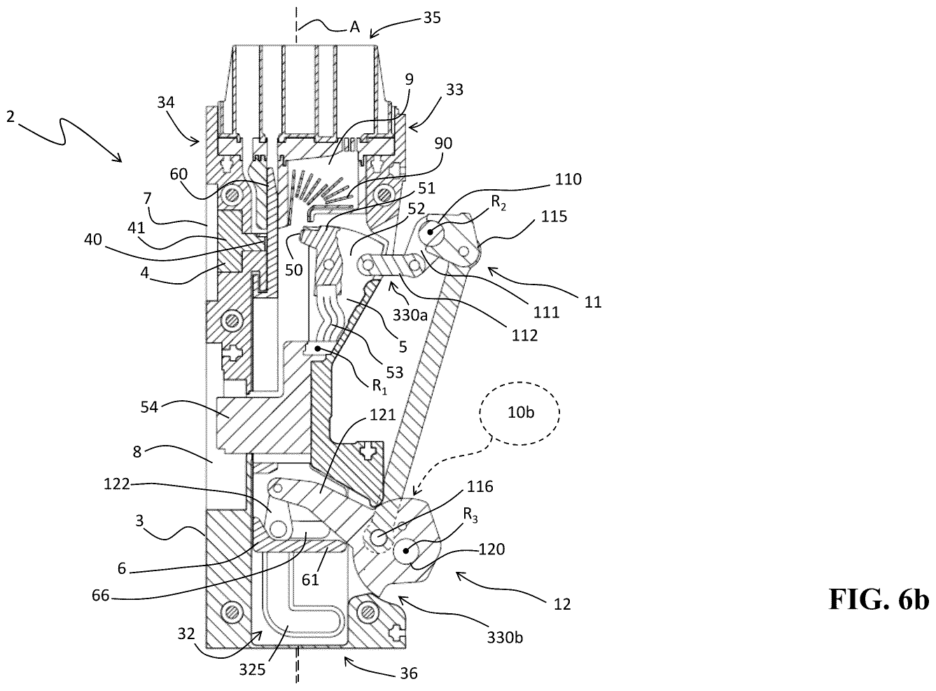

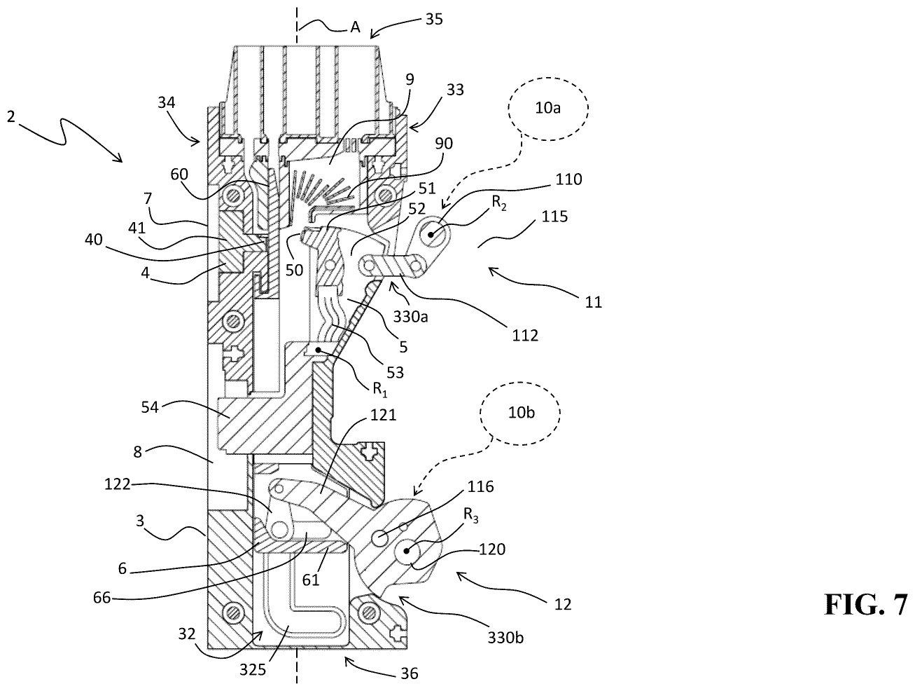

In some embodiments, the outer shell 3 of a switch pole extends along a corresponding main longitudinal axis A, for example with a parallelepiped-like shape (FIGS. 6-7).

In some embodiments, the outer shell 3 of a switch pole has opposite top and bottom walls 35, 36, opposite front and rear walls 33, 34 oriented perpendicularly to said top and bottom walls, and opposite side walls 32 oriented perpendicularly to the other walls of the outer shell.

For the sake of clarity, it is specified that relative terms used in this disclosure, e.g., “front”, “rear”, “lateral”, “upper”, “lower”, “top” and “bottom” relate to a switch pole in its normal installation conditions as shown in FIGS. 2-5.

Conveniently, the outer shell 3 may be made of multiple parts of electrically insulating material that can be mutually joined with fixing means of known type.

A switch pole 2 comprises a first pole terminal 7 and a second pole terminal 8.

Each pole terminal 7, 8 is electrically connectable with a corresponding conductor of an electric line or with a corresponding pole terminal of another switch pole.

In some embodiments, the pole terminals 7, 8 are formed by corresponding shaped conductive bodies or plates fixed to the outer shell 3 of the switch pole.

In some embodiments, the first and second pole terminals 7, 8 are arranged at the rear wall 34 of the outer shell respectively in proximal and distal positions relative to the lower wall 36 of the outer shell. In this way, each pole terminal can be easily coupled to a corresponding line conductor. For the sake of clarity, it is specified that the terms “coupled”, “decoupled” or “couplable” used in this disclosure relate to both an electrical and mechanical coupling/decoupling of different parts unless otherwise specified or self-evident from the description or figures.

According to the present disclosure, a switch pole 2 comprises a fixed contact assembly 4 and a movable contact assembly 5 arranged in a contact region of the switch pole (FIGS. 6-7).

The fixed contact assembly 4 comprises at least a fixed contact member 40 electrically connected to the first pole terminal 7.

In some embodiments of the present disclosure, the fixed contact assembly 4 can comprise a single fixed contact member 40. In other embodiments of the present disclosure, the fixed contact assembly 4 can comprise multiple contact members 40 electrically connected to the first pole terminal 7.

In some embodiments, a fixed contact member 40 is formed by a conductive tip arranged on a conductive base 41 fixed to the outer shell 3 and electrically connected to the first pole terminal 7, for example by a direct coupling with this latter as shown in FIGS. 6-7.

The movable contact assembly 5 comprises at least a movable contact member 50 electrically connected to the second pole terminal 8.

In some embodiments of the present disclosure, the movable contact assembly 5 can comprise a single movable contact member 50. In other embodiments of the present disclosure, the movable contact assembly 5 can comprise multiple contact members 50 electrically connected to the second pole terminal 8.

In some embodiments, a movable contact member 50 is formed by a conductive finger protruding from a conductive head 51 electrically connected to the second pole terminal 8, for example by means of a braid 53 and a solid conductor 54. This latter can be fixed to the outer shell 3 and coupled to the second pole terminal 8 as shown in FIGS. 6-7.

The movable contact assembly 5 is reversibly movable around a first rotation axis R₁. In some embodiments, this latter is perpendicular to the side walls 32 of the insulating shell 3 of the switch pole (the rotation axis R₁ is perpendicular the plane of FIGS. 6-7).

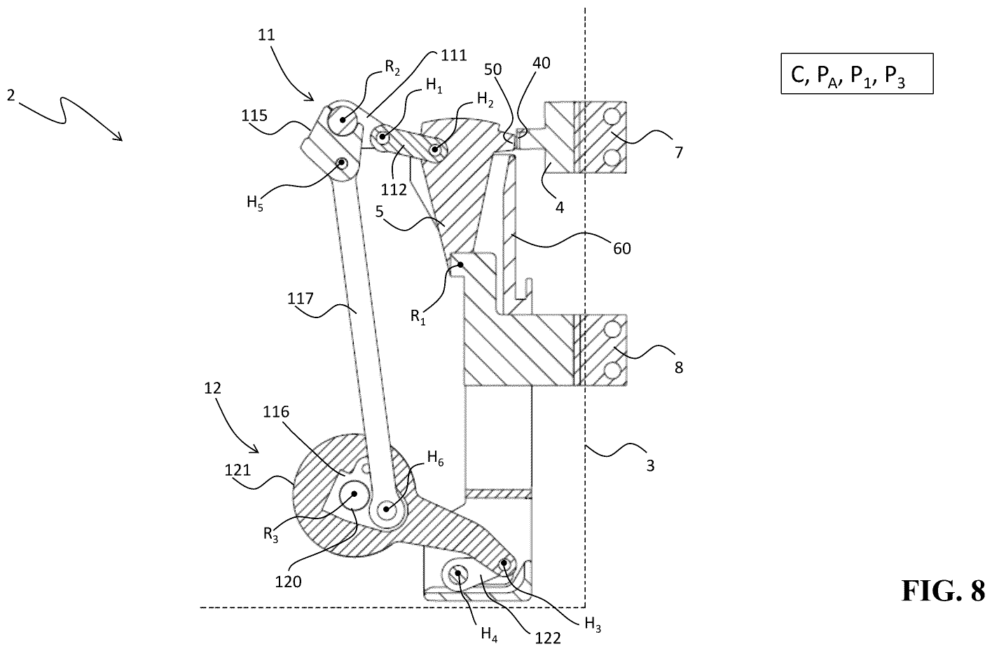

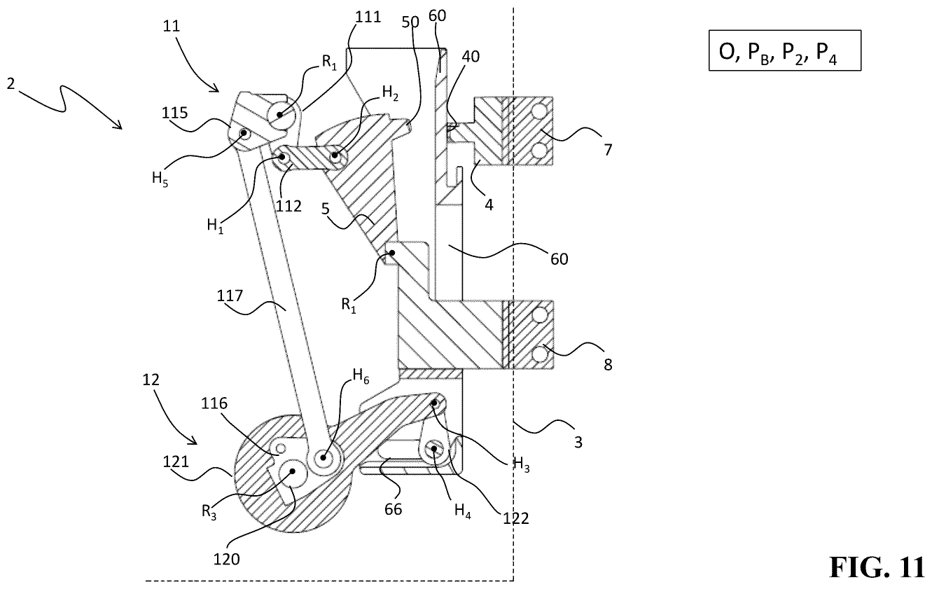

The movable contact assembly 5 is reversibly movable, about the first rotation axis R₁, between a coupled position C (FIG. 8), at which each movable contact member 50 is coupled with a corresponding fixed contact member 40, and an uncoupled position O (FIG. 11), at which each movable contact member 50 is separated from the corresponding fixed contact member 40.

When the movable contact assembly 5 of a switch pole is in a coupled position C, an electric current can flow along the switch pole between the pole terminals 7, 8. The switching apparatus is thus in a closed condition.

When the movable contact assembly 5 of a switch pole is in an uncoupled position O, no electric current can flow along said switch pole. The switching apparatus is thus in an open condition. During an opening maneuver of the switching apparatus (transition from a closed condition to an open condition), the movable contact assembly 5 of each switch pole moves from a coupled position C to an uncoupled position O upon receiving an actuation force.

During a closing maneuver of the switching apparatus (transition from an open condition to a closed condition), the movable contact assembly 5 of each switch pole moves from an uncoupled position O to a coupled position C upon receiving an actuation force.

In some embodiments, the movable contact assembly 5 comprises a supporting structure 52 for supporting each movable contact member 50 mounted on the above-mentioned conductive head 51. Such a supporting structure can conveniently rotate about the rotation axis R₁ and it is mechanically coupled to suitable mechanical means configured to actuate the movable contact assembly 5 as better explained in the following.

In some embodiments, a switch pole 2 comprises an arc chamber 9 arranged at an arc extinguishing region of the switch pole positioned above and in communication with the aforesaid contact region of the switch pole (FIGS. 6-7).

The arc chamber 9 comprises a plurality of arc-breaking elements 90 designed to extinguish possible electric arcs arising between the contact members 40, 50 when these latter separate during an opening maneuver of the switching apparatus (FIGS. 8-11).

In some embodiments, the arc-breaking elements 90 of a switch pole include a series of arc-breaking plates (e.g., contoured metallic or ceramic plates) arranged in parallel, advantageously arranged along reference planes parallel to the front and rear walls 33, 34 of the outer shell 3 at subsequent positions between these latter walls 33, 34 and at increasing distances from the fixed contact assembly 4.

In general, the fixed contact assembly 4, the movable contact assembly 5 and the arc chamber 9 may be realized according to solutions of known type. Therefore, in the following, these components will be described only with reference to the aspects of interest of the present disclosure for the sake of brevity.

According to the present disclosure, the switching apparatus 1 comprises a movable barrier structure 6 for each switch pole 2. Each movable barrier structure 6 includes at least a barrier member 60 made of an electrically insulating material.

The movable barrier structure 6 of a switch pole is translationally movable between a first barrier position P_{A} and a second barrier position P_{B} along a translation axis, which is perpendicular to the first rotation axis R₁.

In some embodiments, the translation axis of each movable barrier structure 6 is parallel to or coincides with the main longitudinal axis A of the corresponding switch pole.

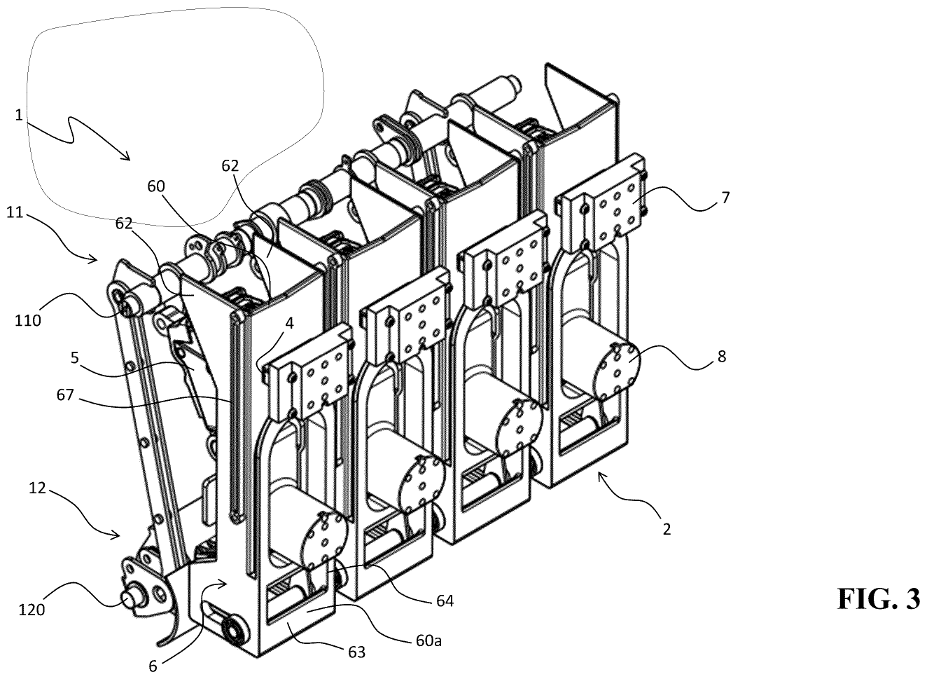

According to the embodiments shown in the cited figures, the movable barrier structure 6 includes a first wall 60a extending along the main longitudinal axis A of the corresponding switch pole and is oriented in such a way to face at least partially the rear wall 34 of the outer shell (FIG. 3).

The first wall 60a includes opposite upper and lower portions 60, 63 arranged respectively in proximal position and distal position relative to the contact region of the switch pole (or relative to the top wall 35 of the outer shell).

The upper portion 60 of the first wall 60a forms a main barrier member of the movable barrier structure 6.

In some embodiments, the first wall 60a comprises a slot 64 arranged at level of the second terminal 8 of the switch pole and oriented in parallel to the main longitudinal axis A of the switch pole. Conveniently, the solid conductor 54 of the movable contact assembly 5, which electrically connects the one or more contact members 50 with the second pole terminal 8, protrudes through the slot 64. The barrier structure 6 can thus translationally move relative to the pole terminals 7, 8 and the outer shell 3 of the switch pole.

In some embodiments, the movable barrier structure 6 includes also a pair of second walls 60b extending along the main longitudinal axis A of the corresponding switch pole in parallel to the first wall. The second walls 60b are oriented perpendicularly to the first wall 60a in such a way that each of them faces at least partially a corresponding side wall 32 of the outer shell.

The movable barrier structure 6 is thus shaped with an open-box configuration oriented in such a way to be open towards the front wall 33 of the outer shell 3 and having a U-shaped section along a plane perpendicular to the main longitudinal axis A of the switch pole.

In some embodiments, each second wall 60b includes opposite upper and lower portions 62, 69 arranged respectively in proximal position and distal position relative to the contact region of the switch pole (or relative to the top wall 35 of the outer shell).

In some embodiments, the upper portion 62 of each second wall 60b is shaped like a lateral wing protruding perpendicularly from the upper portion 60 of the first wall 60 and extending towards the front wall 33 of the outer shell 3 of the switch pole.

The upper portion 62 of each second wall 60b forms an additional barrier member of the movable barrier structure 6.

In some embodiments, the upper portion 62 of each second wall 60b includes a guiding edge 67 outwardly protruding towards a corresponding side wall 32 of the outer shell 3 of the switch pole, which faces said second wall 60b.

The guiding edge 67 is slidingly coupled to a guiding edge (not shown) of the corresponding side wall 32 of the outer shell 3. In this way, the barrier structure 6 can translationally move relative to the outer shell 3 of the switch pole while remaining supported by this latter.

In some embodiments, the lower portion 69 of each second wall 60b forms a coupling portion of the movable barrier structure 6, at which said movable barrier structure is mechanically coupled coupled to corresponding mechanical means configured to actuate said movable barrier structure as better explained in the following.

According to other embodiments of the present disclosure, the movable barrier structure 6 may be differently arranged from the solution shown in the cited figures. In any case, however, the movable barrier structure 6 includes at least a barrier member made of an electrically insulating material, which corresponds to and has the functionalities of the upper portion 60 of the first wall 60a of the movable barrier structure 6 in the embodiments shown in the cited figures.

According to the present disclosure, the switching apparatus 1 comprises a first kinematic assembly 11 and a second kinematic assembly 12.

The first kinematic assembly 11 is mechanically coupled to the movable contact assembly 5 of each switch pole and is configured to actuate this latter upon receiving an actuation force.

The second kinematic assembly 12 is mechanically coupled to the movable barrier structure 6 of each switch pole and is configured to actuate this latter upon receiving an actuation force.

The first and second kinematic assemblies 11, 12 are configured to actuate the movable contact assembly 5 and the movable barrier structure 6 of each switch pole in a synchronized manner in such way that the movable barrier structure 6 moves between the above-mentioned first and second barrier positions P_{A}, P_{B}, when the movable contact assembly 5 moves between the above-mentioned coupled and uncoupled positions C, O (FIGS. 8-11).

In particular, the first and second kinematic assemblies 11, 12 are configured to actuate the movable contact assembly 5 and the movable barrier structure 6 of each switch pole in such a way that the movable barrier structure 6 moves from the first barrier position P_{A} to the second barrier position P_{B}, when the movable contact assembly 5 moves from the coupled position C to the uncoupled position O (opening maneuver of the switching apparatus). The first and second kinematic assemblies 11, 12 are further configured to actuate the movable contact assembly 5 and the movable barrier structure 6 of each switch pole in such a way that the movable barrier structure 6 moves from the second barrier position P_{B} to the first barrier position P_{A}, when the movable contact assembly 5 moves from the uncoupled position O to the coupled position C (closing maneuver of the switching apparatus).

The movable barrier structure 6 is in the above-mentioned first barrier position P_{A}, when the movable contact assembly 5 is in the above-mentioned coupled position C. In this case, no movable barrier member is interposed between the one or more movable contact members 50 and the one or more fixed contact member 40 of the switch pole.

The movable barrier structure 6 is in the above-mentioned second barrier position P_{B}, when the movable contact assembly 5 is in the above-mentioned uncoupled position O. In this case, at least a barrier member 60 is interposed between the one or more movable contact members 50 and the one or more fixed contact members 40 of the switch pole.

As it is apparent from above, according to the present disclosure, at least a barrier member 60 of the movable barrier structure 6 moves into a separation gap between the electric contacts 40, 50 of the switch pole during an opening maneuver of the switching apparatus and moves away from said separation gap during a closing maneuver of the switching apparatus.

This solution provides relevant advantages.

By interposing between the electric contacts 40, 50 of the switch pole, the barrier member 60 interferes with the conductive paths followed by possible electric arcs generated at the separation gap between said electric contacts during an opening maneuver of the switching apparatus. The barrier member 60 can thus perturb the arising electric arcs by increasing of the length of these latter, which reduces the circulating current and favors the arc-quenching process. In addition, the barrier member 60 causes a displacement of the arising electric arcs towards the arc-extinguishing region of the switch pole, where the arc-chamber 9 is arranged.

During an opening maneuver of the switching apparatus the barrier member 60 moves through a region of the switch pole that is conveniently in communication with the arc chamber 9. This further favors the displacement and the length increase of possible electric arcs.

According to possible variants of the present disclosure (not shown), the arc chamber 90 can be split in two portions arranged at opposite sides of the barrier member 60 of the movable barrier structure to further improve the above-mentioned displacement process of possible electric arcs.

In some embodiments, at least the barrier member 60 of the movable barrier structure is made of an electrically insulating material having arc-quenching properties. This solution remarkably favors the extinguishing process of possible electric arcs arising during an opening maneuver of the switching apparatus.

In the embodiments shown in the cited figures, the additional barrier members 62 of the movable structure do not move into the separation gap between the electric contacts 40, 50 of the switch pole during an opening maneuver of the switching apparatus.

However, they can favor the segregation of the hot gases generated during the separation of the electric contacts 40, 50 and convey the hot gases towards the arc-extinguishing region of the switch pole, where they can be effectively cooled down and directed towards suitable exhaust openings at the top wall 35 of the outer shell 3 of the switch pole. The probability that electric arcs strike towards other conductive components of the switch pole is thus drastically reduced.

In view of the above, it is apparent that the solution provided by the present disclosure is particularly effective when the switching device 1 carries out an opening maneuver to interrupt high currents (e.g., short-circuit currents) flowing along the electric poles.

The switching apparatus 1 thus shows an excellent switching efficiency and provides excellent performances in terms of interruption ratings during the opening maneuvers, even for DC currents at relatively high voltage levels (e.g. above 1.5 kV).

According to an aspect of the present disclosure, the first kinematic assembly 11 is reversibly movable between a first operating position P₁ and a second operating position P₂ upon receiving an actuation force (FIGS. 8-11).

The first kinematic assembly 11 is configured to provide actuation forces to move the movable contact assembly 5 of each switch pole between the above-mentioned coupled and uncoupled positions C, O, when it moves between the above-mentioned first and second operating positions P₁, P₂, respectively.

According to an aspect of the present disclosure, the second kinematic assembly 12 is reversibly movable between a third operating position P₃ and a fourth operating position P₄ upon receiving an actuation force (FIGS. 8-11).

The second kinematic assembly 12 is configured to provide actuation forces to move the movable barrier structure 6 of each switch pole between the above-mentioned first and second barrier positions P_{A}, P_{B}, when it moves between the above-mentioned third and fourth operating positions P₃, P₄, respectively.

In some embodiments, the switching apparatus comprises an actuation assembly including actuation means to move the first and second kinematic assemblies 11, 12 during an opening or closing maneuver of the switching apparatus. Such an actuation assembly can be arranged according to the needs, for example side-by-side with the electric poles 2, at a front side or a rear side of the switching apparatus.

According to some embodiments of the present disclosure (FIGS. 2-4 and 6), the above-mentioned actuation assembly includes first actuation means 10a mechanically coupled to the first kinematic assembly 11 of each switch pole to move each first kinematic assembly between the above-mentioned first and second operating positions P₁, P₂ (i.e. during an opening or closing maneuver of the switching apparatus).

In these cases, the first kinematic assembly 11 is configured to provide actuation forces to move the second kinematic assembly 12 between the above-mentioned third and fourth operating positions P₃, P₄, when said first kinematic assembly moves between the above-mentioned first and second operating positions P₁, P₂, respectively (i.e. during an opening or closing maneuver of the switching apparatus). The first kinematic assembly 11 is thus mechanically coupled to the second kinematic assembly 12 for one or more switch poles and it can suitably actuate the second kinematic assembly 12 upon receiving an actuation force from the first actuating means 10a.

According to other embodiments of the present disclosure (FIGS. 2-4, 6b), the actuation assembly 10 includes second actuation means 10b mechanically coupled to the second kinematic assembly 12 of each switch pole to move each second kinematic assembly between the above-mentioned third and fourth operating positions P₃, P₄ (i.e. during an opening or closing maneuver of the switching apparatus).

In these cases, the second kinematic assembly 12 is configured to provide actuation forces to move the first kinematic assembly 11 between the above-mentioned first and second operating positions P₁, P₂, when said first kinematic assembly moves between the above-mentioned third and fourth operating positions P₃, P₄, respectively (i.e. during an opening or closing maneuver of the switching apparatus). The second kinematic assembly 12 is mechanically coupled to the first kinematic assembly 11 for one or more switch poles and it can suitably actuate the first kinematic assembly 11 upon receiving an actuation force from the second actuating means 10b.

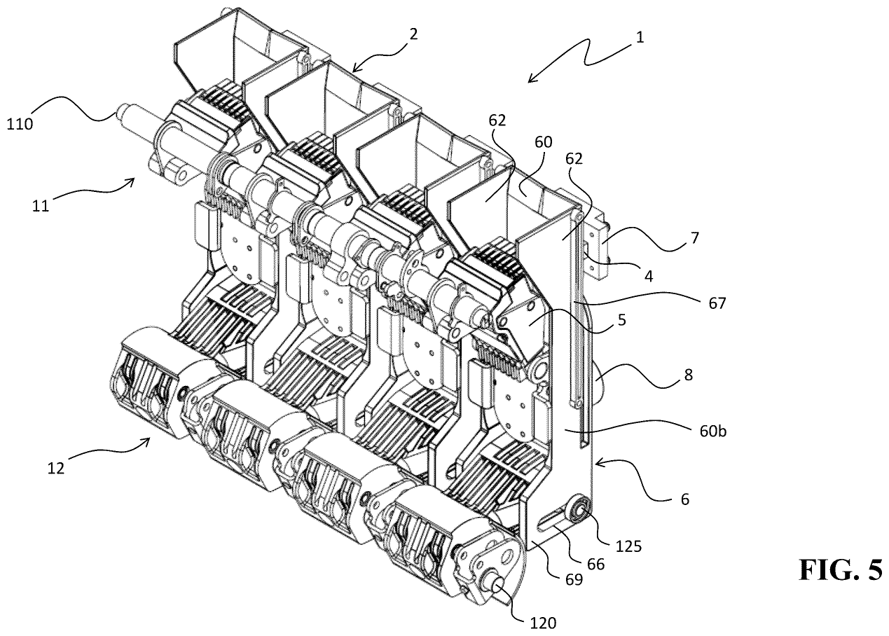

According to other embodiments of the present disclosure (FIGS. 5 and 7), the above-mentioned actuation assembly includes both first and second actuation means 10a, 10b mechanically coupled to the first and second kinematic assemblies 11, 12 of each switch pole, respectively. In these cases, the first and second kinematic assemblies 11, 12 are mechanically decoupled and they operate independently one from another even if they are configured to actuate the movable contact assembly 5 and the movable barrier structure 6 in each switch pole synchronously as explained above.

In general, the above-mentioned first actuation means 10a and the above-mentioned second actuation means 10b may be realized according to solutions of known type. For example, they can include suitable actuators mechanical type or electromagnetic type and suitable kinematic chains to couple mechanically said actuators with the first the first kinematic assembly 11 and, possibly, with the second kinematic assembly 12.

According to an aspect of the present disclosure, the first and second kinematic assemblies 11, 12 are configured in such a way that, during an opening maneuver of the switching apparatus, the second kinematic assembly 12 starts actuating the movable barrier structure 6 of each switch pole from the first barrier position P_{A} to the second barrier position P_{B} with a time delay relative an instant, at which the first kinematic assembly 11 starts actuating the movable contact assembly 5 of the switch pole from the coupled position C to the uncoupled position O.

In other words, during an opening maneuver of the switching apparatus, the movable barrier structure 6 of each switch pole moves with a time delay relative to the movable contact assembly 5 of the corresponding switch pole.

This solution is quite advantageous as it allows reducing the run length of the movable barrier structure 6 between the first and second barrier positions P_{A}, P_{B}. This allows reducing the size of the switch poles along a vertical direction (main longitudinal axis A) while ensuring a suitable translational movement for the movable barrier structure.

According to an aspect of the present disclosure, the first kinematic assembly 11 comprises a first motion transmission shaft 110 movable around a second rotation axis R₂ parallel to the first rotation axis R₁ of each movable contact assembly 5 of the switch poles.

The first kinematic assembly 11 further comprises a first motion transmission mechanism 111, 112 coupling the first motion transmission shaft 110 to the movable contact assembly 5 of each switch pole. The arrangement of a common motion transmission shaft and of a motion transmission mechanism for each switch pole facilitates the simultaneous actuation of the movable contact assembly 5 of each switch pole.

The first motion transmission mechanism further comprises a first lever member 111 coupled to the first motion transmission shaft 110 in such a way to rotate together with this latter.

The first motion mechanism additionally comprises a second lever member 112 having a first hinging axis H₁ with the first lever member 111 and a second hinging axis H₂ with the movable contact assembly 5.

The first and second hinging axes H₁, H₂ are parallel one to another and to the second rotation axis R₂ of the first motion transmission shaft 110. They are thus parallel to the first rotation axis R₁ of the movable contact assembly 5 of each switch pole.

In some embodiments, the first motion transmission shaft 110 and the first lever member 111 of each first motion transmission mechanism are arranged externally to the outer shell of each switch pole. The second lever member 112 of each first motion transmission mechanism passes through a first aperture 330a of the front wall 33 of the outer shell 3 to join with the movable contact assembly 5 (more particularly with the supporting structure 52 of the movable contact assembly as shown in FIGS. 6-7).

In some embodiments, the first lever member 111 has a cam shape and is joined to the first motion transmission shaft 110.

In some embodiments, the second lever member 112 comprises a pair of second levers (for example having a rectilinear shape or an equivalent shape), which are spaced one from another along the first and second hinging axes H₁, H₂. These paired levers are joined together and to the first lever member 111 by a coupling pin arranged along the first hinging axis H₁. Additionally, they are joined together and to the movable contact assembly 5 by a further coupling pin arranged along the second hinging axis H₂ and passing through a suitable coupling cavity of the supporting structure 52.

According to an aspect of the present disclosure, the second kinematic assembly 12 comprises a second motion transmission shaft 120 movable around a third rotation axis R₃ parallel to the first rotation axis R₁ of each movable contact assembly 5 of the switch poles (and therefore to the second rotation axis R₂ of the first motion transmission shaft 110).

The second kinematic assembly 12 further comprises a second motion transmission mechanism 121, 122 coupling the second motion transmission shaft 120 to the movable barrier structure 6 of each switch pole. As mentioned above, the arrangement of a common motion transmission shaft and of a motion transmission mechanism for each switch pole facilitates the simultaneous actuation of the movable barrier structure 6 of each switch pole.

The second motion transmission mechanism comprises a third lever member 121 coupled to the second motion transmission shaft 120 in such a way to rotate together with this latter.

The second motion transmission mechanism comprises additionally comprises a fourth lever member 122 having a third hinging axis H₃ with the third lever member 121 and a fourth hinging axis H₄ with the movable barrier structure 6.

The third and fourth hinging axes H₃, H₄ are parallel one to another and to the third rotation axis R₃ of the second motion transmission shaft 120. They are thus parallel to the first rotation axis R₁ of the movable contact assembly 5 of each switch pole, to the second rotation axis R₂ of the first motion transmission shaft 110 and to the first and second hinging axes H₁, H₂.

In some embodiments, the second motion transmission shaft 120 is arranged externally to the outer shell of each switch pole. The third lever member 121 of each second motion transmission mechanism passes through a second aperture 330b of the front wall 33 of the outer shell 3 of the corresponding switch pole (FIGS. 6-7).

The fourth lever member 122 of each second motion transmission mechanism is accommodated in the portion of internal volume delimited by the movable barrier structure 6 of the switch pole. The fourth lever member 122 is joined with the movable barrier structure 6 at one or more coupling portions of this latter (for example at a coupling portion 69 of each second wall 60b of said movable barrier structure).

In some embodiments, the fourth hinging axis H₄ of the fourth lever member 122 is slidable along one or more slots 66 of one or more corresponding coupling portions 69 of the movable barrier structure 6, at which the fourth lever member is coupled to said movable barrier structure.

In some embodiments, the lower portion 69 of each second wall 60b includes a slot 66, along which the fourth hinging axis H₄ of the fourth lever member 122 can slide. Each slot 66 is oriented perpendicularly to the main longitudinal axis A of the switch pole and to the first wall 60a of the movable barrier structure.

As it will be apparent from the following, this solution allows the second kinematic assembly 12 to actuate the movable barrier structure 6 of each switch pole with a time delay compared to the actuation of the movable contact assembly 5 of the switch pole by the first kinematic assembly 11.

In some embodiments, the third lever member 121 comprises a main coupling body (for example having a cylindrical section) with the second first motion transmission shaft 120 and a lever portion protruding from said main coupling body.

In some embodiments, the fourth lever member 122 comprises a pair of levers having, for example, a triangular shape (or an equivalent shape), which are spaced one from another along the third and fourth hinging axes H₃, H₄. These paired levers are joined to the third lever member 121 by a coupling pin arranged along the third hinging axis H₃ and by a further coupling pin arranged along the fourth hinging axis H₄ and passing through suitable coupling apertures (for example, the slots 66) of the movable barrier structure 6.

Advantageously, the coupling pin arranged along the fourth hinging axis H₄ has opposite ends outwardly protruding from the movable barrier structure 6 and provided with suitable rollers 125, which can slide along corresponding grooves 325 obtained at the opposite side walls 32 of the outer shell 3 of the switch pole (FIGS. 2-3, 6-7). This solution further contributes to increase the stability of the movable barrier assembly while moving between the first and second barrier positions P_{A}, P_{B}.

According to some embodiments of the present disclosure (FIGS. 2-4, 6, 6a, 6b), the first kinematic assembly 11 comprises, for one or more switch poles 2, a third motion transmission mechanism 115, 116, 117 mechanically coupling the first motion transmission shaft 110 to the second kinematic assembly 12, more particularly the first motion transmission shaft 110 to the second motion transmission shaft 120.

By virtue of the third motion transmission mechanisms 115, 116, 177 arranged in one or more switch poles, the first kinematic assembly 11 can interact with the second kinematic assembly 12 during an opening or closing maneuver of the switching apparatus.

According to some embodiments of the present disclosure (FIGS. 2-3), the first kinematic assembly 11 comprises a third motion transmission mechanism 115, 116, 117 just for a pair of switch poles of the switching apparatus, which are symmetrically positioned along the first and second motion transmission axes 110, 120 (for example at peripheral positions). Apparently, such a symmetrical arrangement allows the first kinematic assembly 11 to actuate the second kinematic assembly 12 by providing suitably balanced actuation forces.

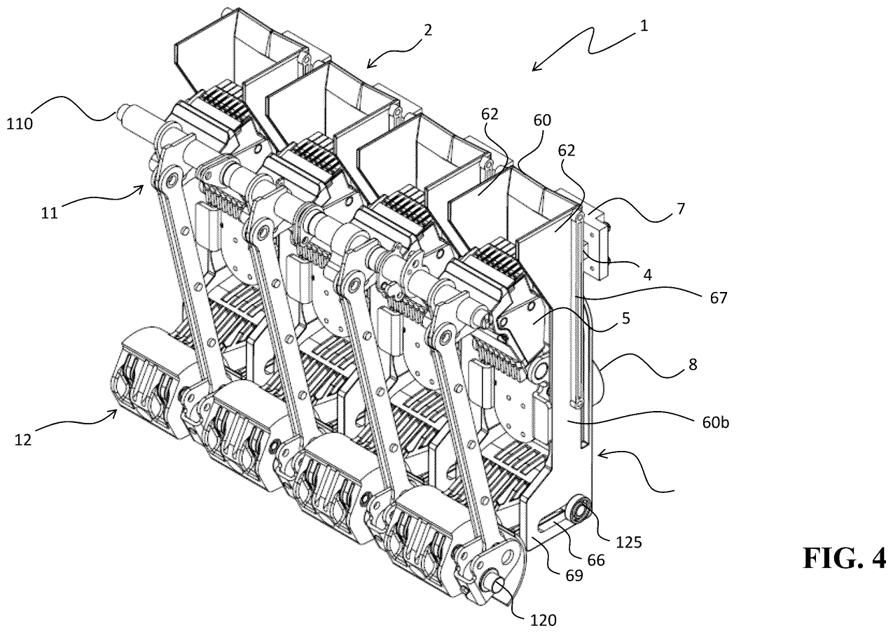

According to other embodiments of the present disclosure (FIG. 4), the first kinematic assembly 11 comprises a third motion transmission mechanism 115, 116, 117 for each switch pole of the switching apparatus.

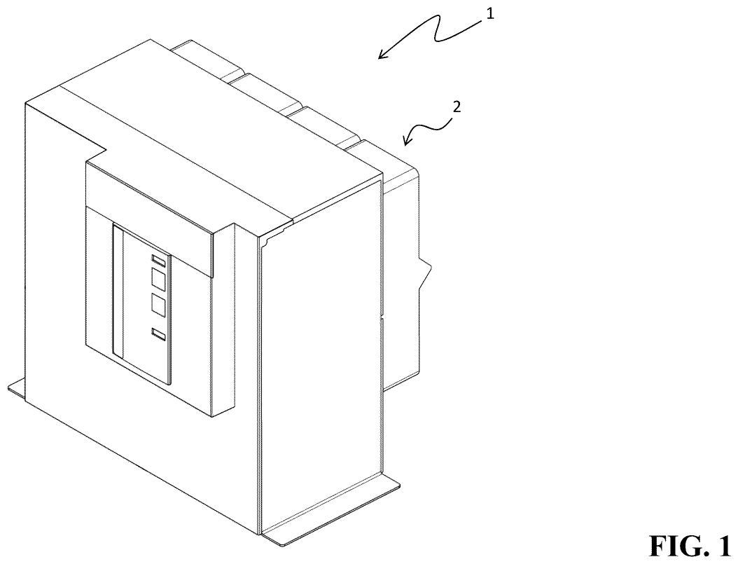

According to an aspect of the present disclosure, each third motion mechanism comprises a fifth lever member 115 coupled to the first motion transmission shaft 110 in such a way to rotate together with the first motion transmission shaft, a sixth lever member 116 coupled to the second motion transmission shaft 120 in such a way to rotate together with the second motion transmission shaft 120, and a seventh lever member 117 having a fifth hinging axis H₅ with the fifth lever member 115 and a sixth hinging axis H₆ with the sixth lever member 116 (FIGS. 1-4, 6-6a, 8-11).

The fifth and sixth hinging axes H₅, H₆ are parallel one to another and to the third rotation axis R₃ of the second motion transmission shaft 120. They are thus parallel to the first rotation axis R₁ of the movable contact assembly 5 of each switch pole, to the second rotation axis R₂ of the first motion transmission shaft 110 and to the first, second, third, fourth hinging axes H₁, H₂, H₃, H₄.

In some embodiments, the fifth lever member 115 and the sixth lever member 116 comprise each a lever having a cam shape, which are joined to the first motion transmission shaft 110 and to the second motion transmission shaft 120, respectively.

In some embodiments, the seventh lever member 117 comprises a pair of levers (for example having a rectilinear shape or an equivalent shape), which are spaced one from another along the fifth and sixth hinging axes H₅, H₆. These paired levers are joined together and to the first lever member 115 by a coupling pin arranged along the fifth hinging axis H₅. They are further joined together and to the sixth lever member 116 by a coupling pin arranged along the sixth hinging axis H₆.

The operation of a switch pole of the switching apparatus, according to the embodiment of FIGS. 4, 6-6a, is now described in more details with reference to FIGS. 8-11.

Closed condition of the switching apparatus:

The switching apparatus 1 is supposed to be in a closed condition (FIG. 8).

In this situation, for each switch pole, the movable contact assembly 5 is in a coupled position C and it has its (one or more) movable contact members 50 coupled to corresponding (one or more) fixed contact members 40 of the fixed contact assembly 4. A current can therefore flow between the pole terminals 7, 8 of each switch pole.

The movable barrier structure 6 is in a first barrier position P_{A}. No movable barrier member 60 is interposed between the electric contacts 40, 50 of the switch pole.

The first kinematic assembly 11 is in the first operating position P₁ while the second kinematic assembly 12 is in the third operating position P₃. The hinging axis H₄ of the fourth lever member 122 of the second kinematic assembly 12 is positioned at a first end of the coupling slots 66 of the movable barrier assembly 6, at which the second kinematic assembly 12 (namely the fourth lever member 122) is coupled to the movable barrier assembly 6.

Opening maneuver of the switching apparatus:

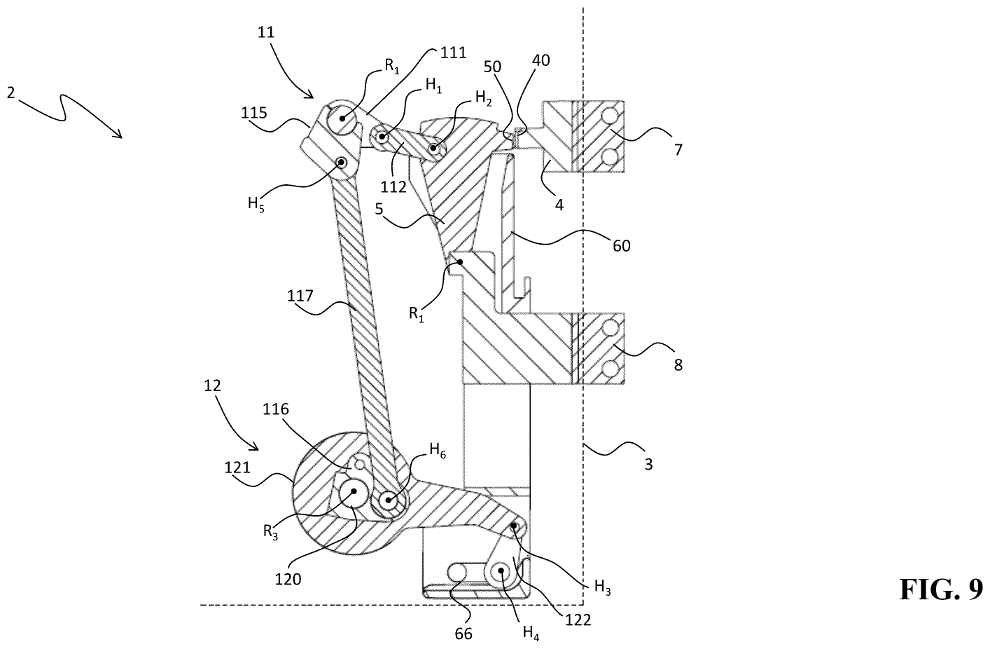

FIG. 9 shows an initial stage of the opening maneuver.

To carry out an opening maneuver, the first actuation means 10a of the actuation assembly move the first motion transmission shaft 110 according a clockwise direction about the second rotation axis R₂ (reference is made to an observation plane of FIGS. 8-11).

The movement of the first motion transmission shaft 110 makes the first lever member 111 rotate according to a same clockwise direction and the second lever member 112 rotate according to a counterclockwise direction.

The movement of the first and second lever members 111, 112 makes the movable contact assembly 5 move about the first rotation axis R₁ according to a counterclockwise direction.

The movable contact assembly 5 moves away from the coupled position C towards an uncoupled position O. The movable contact members 50 of the movable contact assembly 5 move away from the fixed contact members 40 of the fixed contact assembly 4. Electric arcs may arise at the gap region between the electric contacts 40, 50 under separation.

The movement of the first motion transmission shaft 110 according to the clockwise direction further makes the fifth lever member 115 rotate according to a same clockwise direction. Due to this movement of the fifth lever member 115, the seventh lever member 117 exerts a traction force on the sixth lever member 116, which moves according to a counterclockwise direction.

Consequently, also the second motion transmission shaft 120 and the third lever member 121 moves about the third rotation axis R₃ according to a same counterclockwise direction.

The movement of the third lever member 121 makes also the fourth lever member 122 rotate according to a counterclockwise direction.

The hinging axis H₄ of the fourth lever member 122 slides along the slots 66 of the movable barrier structure 6 according to a horizontal translation direction (towards the rear wall 34).

It is noted that, at this stage of the opening maneuver, the movable barrier 6 is not subject to actuation forces due to the translation movement of the hinging axis H₄ of the fourth lever member 122 along the slots 66. The barrier structure 6 thus remains in the first barrier position P_{A} while movable contact assembly 5 is moving towards an uncoupled position O and the electric contacts 40, 50 are separating.

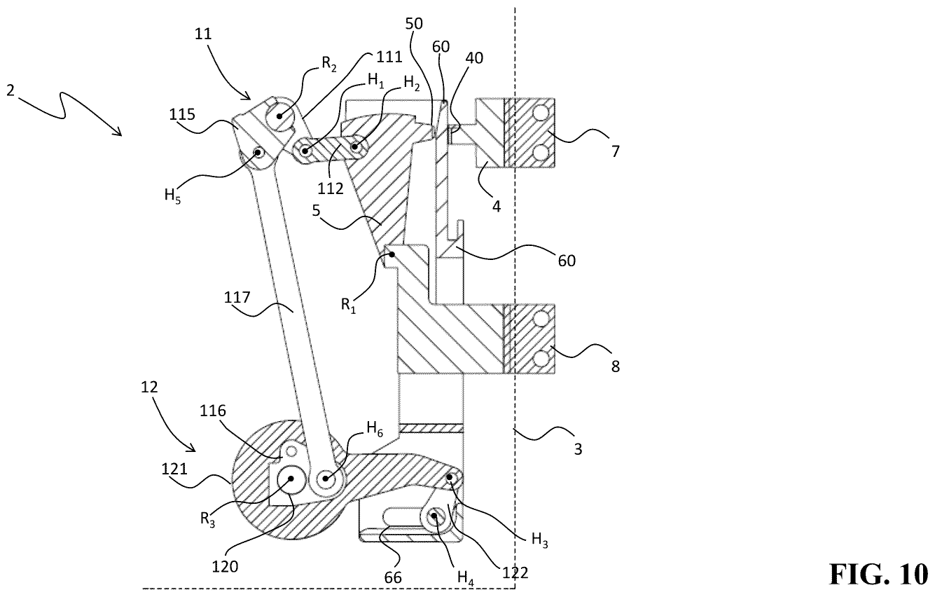

FIG. 10 shows a further stage of the opening maneuver.

The first kinematic assembly 11, the movable contact assembly 5 and the second kinematic assembly 12 continue to move as explained above. The hinging axis H₄ of the fourth lever member 122 has however reached a second end (opposite to the above-mentioned first end) of the slots 66 of the movable barrier member 6 (end-of-run position). Thus, it cannot slide anymore relative to the movable barrier structure 6. In this situation, the movement of the third and fourth lever members 121, 122 makes the movable barrier structure 6 move vertically along a translation direction. The movable barrier member 6 moves from the first barrier position P_{A} towards a second barrier position P_{B}.

It is noted that the sliding coupling between the second kinematic assembly 12 and the movable barrier structure 12 allows introducing a time delay between the instant, at which the movable contact assembly 5 is actuated by the first kinematic assembly 11, and the instant, at which the movable barrier structure 6 is actuated by the second kinematic assembly 12.

While the movable barrier structure 6 is moving towards the second barrier position P_{B}, at least a movable barrier member 60 of the movable barrier structure 6 passes through the gap region between the electric contacts 40, 50 under separation and interposes between these latter.

The arcing paths of possible electric arcs arising between the electric contacts 40, 50 under separation are elongated towards the upper arc extinguishing region. Electric arcs are therefore forced to strike through the arc chamber 9, at which they can be efficiently extinguished.

Open condition of the switching apparatus:

The switching apparatus 1 is supposed to be in an open condition (FIG. 11).

In this situation, for each switch pole, the movable contact assembly 5 is in an uncoupled position O. The movable contact members 50 are separated from the corresponding fixed contact members of the fixed contact assembly 4. A current cannot therefore flow between the pole terminals 7, 8 of each switch pole.

The movable barrier structure 6 is in the second barrier position P_{B}. A movable barrier member 60 of the movable barrier structure 6 is interposed between the separated electric contacts 40, 50 of the switch pole.

The first kinematic assembly 11 is in the second operating position P₂ while the second kinematic assembly 12 is in the fourth operating position P₄.

The hinging axis H₄ of the fourth lever member 122 of the second kinematic assembly 12 is positioned at the second end of the coupling slots 66 of the movable barrier assembly 6.

Closing maneuver:

FIG. 10 shows an initial stage of the closing maneuver.

To carry out a closing maneuver, the first actuation means 10a of the actuation assembly move the first motion transmission shaft 110 about the second rotation axis R₂ according a counterclockwise direction (reference is made to an observation plane of FIGS. 8-11).

The movement of the first motion transmission shaft 110 makes the first lever member 111 rotate according to a same counterclockwise direction and the second lever member 112 rotate according to a clockwise direction.

The movement of the first and second lever members 111, 112 makes the movable contact assembly 5 move about the first rotation axis R₁ according to a clockwise direction.

The movable contact assembly 5 moves away from the uncoupled position O towards the coupled position C. The movable contact members 50 of the movable contact assembly 5 move towards the fixed contact members 40 of the fixed contact assembly 4.

The movement of the first motion transmission shaft 110 according to the counterclockwise direction further makes the fifth lever member 115 rotate according to a same counterclockwise direction.

Due to this movement of the fifth lever member 115, the seventh lever member 117 exerts a pushing force (opposite to the above-mentioned traction force) on the sixth lever member 116, which moves according to a clockwise direction.

Consequently, also the second motion transmission shaft 120 and the third lever member 121 moves according to a same clockwise direction about the third rotation axis R₃.

The movement of the third lever member 121 makes also the fourth lever member 122 rotate according to a clockwise direction.

The movement of the third lever member 121 makes the movable barrier structure 6 move vertically along a translation direction.

The movable barrier member 6 moves from the second barrier position P_{B} towards the first barrier position P_{A}.

At least a movable barrier member 60 of the movable barrier structure 6, which is initially interposed between the electric contacts 40, 50, moves away from the gap region between the electric contacts under coupling.

FIG. 9 shows a further stage of the closing maneuver.

The first kinematic assembly 11, the movable contact assembly 5 and the second kinematic assembly 12 continue to move as explained above.

The movable barrier structure 6 has however reached the first barrier position P_{A}.

The hinging axis H₄ of the fourth lever member 122 slides along the slots 66 of the movable barrier structure 6 according to a horizontal translation direction (towards the front wall 33).

The hinging axis H₄ of the fourth lever member 122 reaches the first end (opposite to the above-mentioned second end) of the slots 66 of the movable barrier member 6 (end-of-run position) when the movable contact assembly 5 reaches the coupled position C and the movable contact members 50 couple to the fixed contact members 40 of the fixed contact assembly 4.

The operation of a switch pole of the switching apparatus, according to the embodiment of FIGS. 2-3, is exactly as described above for the switch poles, in which the third motion mechanism 115, 116, 117 of the first kinematic assembly 11 is present (the peripheral switch poles of the switching apparatus shown in FIGS. 2-3).

The operation of the other switch poles, in which the third motion mechanism 115, 116, 117 of the first kinematic assembly 11 is not present (the central switch poles of the switching apparatus shown in FIGS. 2-3), substantially occurs as described above.

The switching apparatus 1, according to the present disclosure, offers remarkable advantages over the prior art.

The switching apparatus 1 shows an excellent switching efficiency and provides excellent performances in terms of interruption ratings during the opening maneuver.

Differently from traditional switching apparatuses, the switching apparatus 1 can efficiently operate DC currents even at relatively high voltages (e.g. above 1.5 kV). In particular, the interposition of an insulating member 60 of the movable barrier structure 6 between the electric contacts 50, 40 under separation allows achieving outstanding performances in terms of arc quenching during an opening maneuver of the switching apparatus.

The switching apparatus 1 is therefore capable of operating at high current levels, thereby showing improved switching performances when short-circuit currents need to be interrupted.

Additionally, in DC applications, when intended to operate at high voltage levels, the switching apparatus can comprise a reduced number of switch poles electrically connected in series compared to similar devices of the state of the art.

The switching apparatus 1 is thus characterized by a very compact structure and it is particularly simple and cheap to manufacture at industrial level.

The switching apparatus 1 has a simple and robust structure, which is particularly suitable for installation in a LV or MV electric grid.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A switching apparatus for low or medium voltage electrical systems, the switching apparatus comprising one or more switch poles,
wherein, for each switch pole, the switching apparatus comprises:
a first pole terminal and a second pole terminal;
a fixed contact assembly including at least one fixed contact member electrically connected to the first pole terminal; and
a movable contact assembly including at least one movable contact member electrically connected to the second pole terminal, wherein:
the movable contact assembly is reversibly movable around a first rotation axis between a coupled position, at which the at least one movable contact member is coupled with the at least one fixed contact member, and an uncoupled position, at which the at least one movable contact member is separated from the at least one fixed contact member;
for each switch pole, the switching apparatus comprises a movable barrier structure including at least one barrier member made of an electrically insulating material,
the movable barrier structure is translationally movable between a first barrier position and a second barrier position along a translation axis perpendicular to the first rotation axis,
the switching apparatus further comprises a first kinematic assembly, which is coupled to the movable contact assembly of each switch pole and actuates the movable contact assembly upon receiving an actuation force, and a second kinematic assembly, which is coupled to the movable barrier structure of each switch pole and actuates the movable barrier structure upon receiving an actuation force,
the first and second kinematic assemblies actuate the movable contact assembly and the movable barrier structure of each switch pole in a synchronized manner in such a way that the movable barrier structure moves between the first and second barrier positions, when the movable contact assembly moves between the coupled and uncoupled positions, respectively,
the at least one barrier member is not interposed between the at least one movable contact member and the at least one fixed contact member, when the movable barrier structure is in the first barrier position and the movable contact assembly is in the coupled position, and
the at least one barrier member is interposed between the at least one movable contact member and the at least one fixed contact member, when the movable barrier structure is in the second barrier position and the movable contact assembly is in the uncoupled position.

2. The switching apparatus, according to claim 1, wherein during an opening maneuver of the switching apparatus, the second kinematic assembly actuates the movable barrier structure of each switch pole from the first barrier position to the second barrier position with a time delay compared to the actuation of the movable contact assembly of each switch pole from the coupled position to the uncoupled position by the first kinematic assembly.

3. The switching apparatus, according to claim 1, wherein the first kinematic assembly comprises:
a first motion transmission shaft movable around a second rotation axis parallel to the first rotation axis; and,
for each switch pole, a first motion transmission mechanism configured to couple the first motion transmission shaft to the movable contact assembly of the switch pole.

4. The switching apparatus, according to claim 3, wherein the first motion mechanism comprises:
a first lever member coupled to the first motion transmission shaft in such a way as to rotate together with the first motion transmission shaft; and
a second lever member, wherein the second lever member has a first hinging axis with the first lever member and a second hinging axis with the movable contact assembly.

5. The switching apparatus, according to claim 1, wherein the second kinematic assembly comprises:
a second motion transmission shaft movable around a third rotation axis parallel to said first rotation axis; and,
for each switch pole, a second motion transmission mechanism configured to couple the second motion transmission shaft to the movable barrier structure of said switch pole.

6. The switching apparatus, according to claim 5, wherein the second motion mechanism comprises:
a third lever member coupled to the second motion transmission shaft in such a way as to rotate together with the second motion transmission shaft; and
a fourth lever member, wherein the fourth lever member has a third hinging axis with the third lever member and a fourth hinging axis with the movable barrier structure.

7. The switching apparatus, according to claim 6, wherein the fourth hinging axis of the fourth lever member is slidable along a slot of at least one coupling portion of the movable barrier structure, at which the fourth lever member is coupled to the movable barrier structure.

8. The switching apparatus, according to claim 1, further comprising an actuation assembly including a first actuator configured to actuate the first kinematic assembly during an opening or closing maneuver of the switching apparatus.

9. The switching apparatus, according to claim 1, wherein the actuation assembly includes a second actuator configured to actuate the second kinematic assembly during an opening or closing maneuver of the switching apparatus.

10. The switching apparatus, according to claim 1, wherein:
the first kinematic assembly comprises, for one or more switch poles, a third motion transmission mechanism configured to couple the first motion transmission shaft to the second kinematic assembly, and
the first kinematic assembly actuates the second kinematic assembly through the one or more third motion transmission mechanisms during an opening or closing maneuver of the switching apparatus.

11. The switching apparatus, according to claim 10, wherein the third motion mechanism comprises:
a fifth lever member coupled to the first motion transmission shaft in such a way as to rotate together with the first motion transmission shaft;
a sixth lever member coupled to the second motion transmission shaft in such a way as to rotate together with the second motion transmission shaft; and
a seventh lever member, wherein the seventh lever member has a fifth hinging axis with the fifth lever member and a sixth hinging axis with the sixth lever member.

12. The switching apparatus, according to claim 1, wherein the switching apparatus is a low voltage circuit breaker.

13. The switching apparatus, according to claim 4, wherein the second kinematic assembly comprises:
a second motion transmission shaft movable around a third rotation axis parallel to said first rotation axis; and,
for each switch pole, a second motion transmission mechanism configured to couple the second motion transmission shaft to the movable barrier structure of said switch pole.

14. The switching apparatus, according to claim 13, wherein the second motion mechanism comprises:
a third lever member coupled to the second motion transmission shaft in such a way as to rotate together with the second motion transmission shaft; and
a fourth lever member, wherein the fourth lever member defines a third hinging axis with the third lever member and a fourth hinging axis with the movable barrier structure.

15. The switching apparatus, according to claim 14, wherein the fourth hinging axis of the fourth lever member is slidable along a slot-of at least one coupling portion of the movable barrier structure, at which the fourth lever member is coupled to the movable barrier structure.

16. The switching apparatus, according to claim 4, wherein:
the first kinematic assembly comprises, for one or more switch poles, a third motion transmission mechanism configured to couple the first motion transmission shaft to the second kinematic assembly, and
the first kinematic assembly actuates the second kinematic assembly through the one or more third motion transmission mechanisms during an opening or closing maneuver of the switching apparatus.

17. The switching apparatus, according to claim 16, wherein the third motion mechanism comprises:
a fifth lever member coupled to the first motion transmission shaft in such a way as to rotate together with the first motion transmission shaft;
a sixth lever member coupled to the second motion transmission shaft in such a way as to rotate together with the second motion transmission shaft; and
a seventh lever member, wherein the seventh lever member has a fifth hinging axis with the fifth lever member and a sixth hinging axis with the sixth lever member.

18. The switching apparatus, according to claim 4, further comprising an actuation assembly including a first actuator configured to actuate the first kinematic assembly during an opening or closing maneuver of the switching apparatus.

19. The switching apparatus, according to claim 4, wherein the actuation assembly includes a second actuator configured to actuate the second kinematic assembly during an opening or closing maneuver of the switching apparatus.
